(19) United States
(12) Patent Application Publication
(10) Pub. No.: US 2014/0028139 A1
(43) Pub. Date: Jan. 30, 2014

(54) PERMANENT MAGNET ROTOR WITH RESIN-COVERED MAGNET AND LAMINATION FOR THERMAL CONTROL

(71) Applicants: Colin Hamer, Noblesville, IN (US); Bradley D. Chamberlin, Pendleton, IN (US); Alex Creviston, Muncie, IN (US); Koon Hoong Wan, Fishers, IN (US)

(72) Inventors: Colin Hamer, Noblesville, IN (US); Bradley D. Chamberlin, Pendleton, IN (US); Alex Creviston, Muncie, IN (US); Koon Hoong Wan, Fishers, IN (US)

(21) Appl. No.: 13/558,839

(22) Filed: Jul. 26, 2012

(51) Int. Cl. H02K 1/27; B29C 45/14

(52) U.S. Cl. 310/156.11; 264/261

(57) ABSTRACT

A method of forming a rotor includes placing a plurality of laminations into a stack having a plurality of longitudinally extending magnet slots, placing a plurality of permanent magnets into ones of the magnet slots, and injecting a low viscosity epoxy resin into the lamination stack, thereby substantially filling the magnet slots with a portion of the epoxy resin having a thermal conductivity greater than 0.3 Watts/(meter*degree Kelvin) and substantially filling axial spaces between adjacent ones of the laminations with a portion of the epoxy resin having a thermal conductivity less than that of the epoxy resin in the magnet spaces.

### BACKGROUND

The present invention relates generally to heat related properties of an electric rotating machine such as a motor and, more particularly, to a permanent magnet (PM) type rotor structure that provides improved efficiency.

The use of permanent magnets generally improves performance and efficiency of electric machines. For example, a PM type machine has magnetic torque and reluctance torque with high torque density, and generally provides constant power output over a wide range of operating conditions. A PM electric machine generally operates with low torque ripple and low audible noise. The permanent magnets may be placed on the outer perimeter of the machine's rotor (e.g., surface mount, hub mount) or in an interior portion thereof (i.e., interior permanent magnet, IPM). PM electric machines may be employed in hybrid or all-electric vehicles, for example a traction motor operating as a generator when the vehicle is braking and as a motor when the vehicle is accelerating. Other applications may employ PM electrical machines exclusively as motors, for example powering construction and agricultural machinery. A PM electric machine may be used exclusively as a generator, such as for supplying portable electricity.

Rotor cores of PM electrical machines are commonly manufactured by stamping and stacking a large number of sheet metal laminations. In one common form, these rotor cores are provided with axially extending slots for receiving permanent magnets. Magnet slots are typically located near the rotor surface facing the stator. Motor efficiency is generally improved by minimizing the distance between the rotor magnets and the stator. Various methods have been used to install permanent magnets in the magnet slots of the rotor. One of the simplest methods of installing a permanent magnet in a rotor is to simply slide the magnet into the magnet slot and retain the magnet within the slot by a press-fit engagement between the slot and the magnet. Such methods may either leave a void space within the magnet slot after installation of the magnet or completely fill the magnet slot. In another common form, one or more magnet carriers secure the permanent magnets to a rotor core.

In a PM electric machine, attention must be given to the upper operating temperatures of permanent magnet portions inside the rotor. When a peak temperature or peak electrical current (or some combination thereof) exists, it is possible to permanently de-magnetize the permanent magnets, resulting in a loss of performance. Conventional PM rotors are not adequately cooled and this results in lower machine output, possible demagnetization, and heat-related mechanical problems.

### SUMMARY

It is therefore desirable to obviate the above-mentioned disadvantages by providing a structure and method for thermal control of a PM rotor.

According to an exemplary embodiment, a rotor includes a plurality of laminations arranged in a stack having a plurality of longitudinally extending magnet slots, a plurality of permanent magnets in respective ones of the magnet slots, and a low-viscosity epoxy resin encapsulating the permanent magnets and substantially covering each of the laminations in the stack, the epoxy resin having thermal conductivity greater than 0.3 watts/(meter*degree Kelvin).

According to another exemplary embodiment, a method of forming a rotor includes placing a plurality of laminations into a stack having a plurality of longitudinally extending magnet slots, placing a plurality of permanent magnets into ones of the magnet slots, and injecting a low viscosity epoxy resin into the lamination stack, thereby substantially filling the magnet slots with a portion of the epoxy resin having a thermal conductivity greater than 0.3 Watts/(meter*degree Kelvin) and substantially filling axial spaces between adjacent ones of the laminations with a portion of the epoxy resin having a thermal conductivity less than that of the epoxy resin in the magnet spaces.

According to a further exemplary embodiment, a method of forming a rotor includes arranging a plurality of laminations as a stack having a plurality of longitudinally extending magnet slots, placing a plurality of permanent magnets into respective ones of the magnet slots, and substantially encapsulating the permanent magnets and each of the laminations with a low-viscosity epoxy resin having thermal conductivity greater than 0.3 watts/(meter*degree Kelvin).

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic cross sectional view of an electric machine;

FIG. 2 is a perspective view of an interior permanent magnet (IPM) rotor of an electric machine;

FIG. 3 is a schematic view of a permanent magnet;

FIG. 4 is a top plan view of an interior permanent magnet (IPM) rotor of an electric machine;

FIG. 5 is an enlarged view of a portion of the rotor of FIG. 4, the portion grouped as a set of permanent magnets that may be defined as a magnetic pole;

FIG. 6 is a top plan view of an interior permanent magnet (IPM) rotor of an electric machine;

FIG. 7 is an enlarged view of a portion of the rotor of FIG. 6, the portion grouped as a set of permanent magnets that may be defined as a magnetic pole;

FIG. 8 is a partial plan view of a rotor core having permanent magnets encapsulated with a thermally conductive resin, according to an exemplary embodiment; and

FIG. 9 is a flowchart of a process of manufacturing a rotor, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

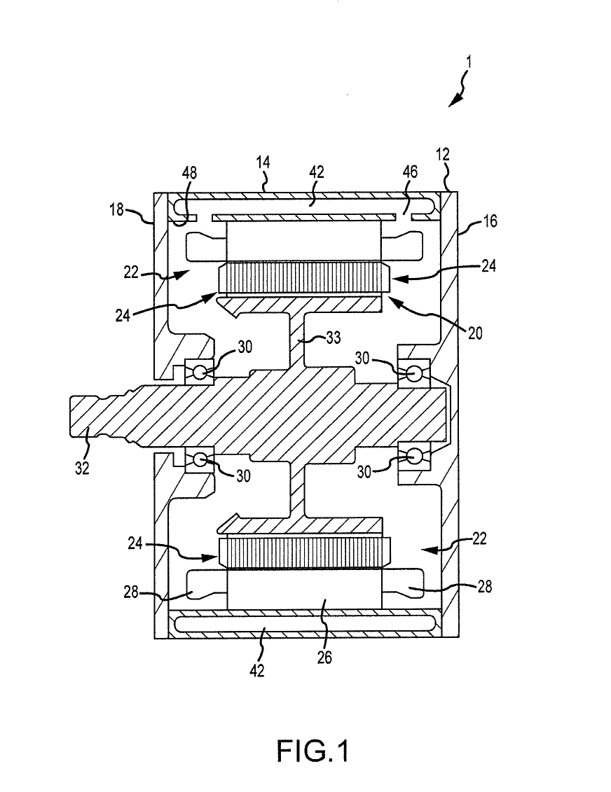

FIG. 1 is a schematic cross sectional view of an exemplary electric machine assembly 1. Electric machine assembly 1 may include a housing 12 that includes a sleeve member 14, a first end cap 16, and a second end cap 18. An electric machine 20 is housed within a machine cavity 22 at least partially defined by sleeve member 14 and end caps 16, 18. Electric machine 20 includes a rotor assembly 24, a stator assembly 26 including stator end turns 28, bearings 30, and an output shaft 32 secured as part of rotor 24. Rotor 24 rotates within stator 26. Rotor assembly 24 is secured to shaft 32 by a rotor hub 33. In alternative embodiments, electric machine 20 may have a “hub-less” design.

In some embodiments, module housing 12 may include at least one coolant jacket 42, for example including passages within sleeve member 14 and stator 26. In various embodiments, coolant jacket 42 substantially circumscribes portions of stator assembly 26, including stator end turns 28. A suitable coolant may include transmission fluid, ethylene glycol, an ethylene glycol/water mixture, water, oil, motor oil, a gas, a mist, any combination thereof, or another substance. A cooling system may include nozzles (not shown) or the like for directing a coolant onto end turns 28. Module housing 12 may include a plurality of coolant jacket apertures 46 so that coolant jacket 42 is in fluid communication with machine cavity 22. Coolant apertures 46 may be positioned substantially adjacent to stator end turns 28 for the directing of coolant to directly contact and thereby cool end turns 28. For example, coolant jacket apertures 46 may be positioned through portions of an inner wall 48 of sleeve member 14. After exiting coolant jacket apertures 46, the coolant flows through portions of machine cavity 22 for cooling other components. In particular, coolant may be directed or sprayed onto hub 33 for cooling of rotor assembly 24. The coolant may be pressurized when it enters the housing 12. After leaving the housing 12, the coolant may flow toward a heat transfer element (not shown) outside of the housing 12, for removing the heat energy received by the coolant. The heat transfer element can be a radiator or a similar heat exchanger device capable of removing heat energy.

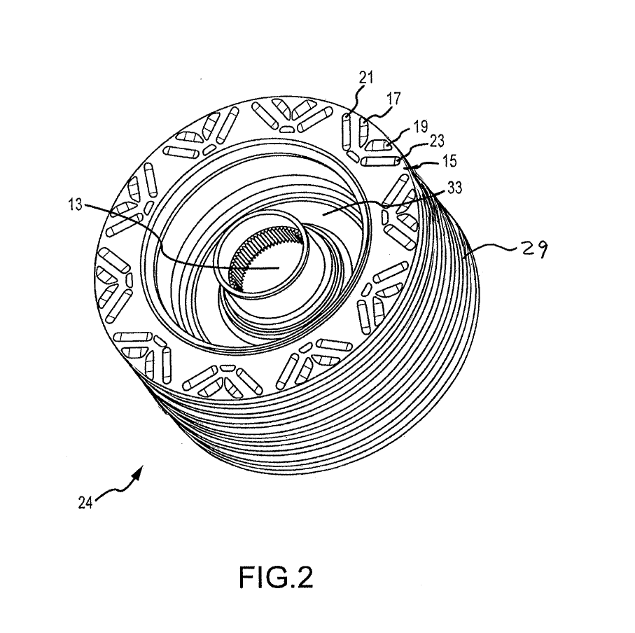

FIG. 2 is a perspective view of an IPM rotor 24 having a hub assembly 33 with a center aperture 13 for securing rotor 24 to shaft 32. Rotor 24 includes a rotor core 15 that is typically formed as a bonded stack of individual metal laminations 29 made, for example, of silicon steel. In various applications, laminations 29 may be formed of other steel such as a cold-rolled type, nickel alloy, cobalt alloy, or other suitable material/grade, typically based on desired motor output, heat rise, weight, cost, permeability, core losses, saturation flux density, and other considerations such as the shape of the hysteresis curve. Permeability and core losses vary with the frequency of flux reversals and with flux density. The exemplary embodiments described herein utilize silicon steel, which may be formed by alloying low carbon steel with small quantities of silicon, whereby the added volume resistivity helps to reduce eddy current losses in the core. Such materials are available in varying grades and thicknesses. Silicon steel is typically graded with M numbers according to their core loss specified in Watts per pound. Rotor core 15 includes a plurality of axially-extending magnet slots 17, 19, 21, 23 each having an elongated shape, for example an elongated oval shape. In addition, although variously illustrated herein with sharp corners and ends, magnet slots 17, 19, 21, 23 typically have rounded ends for reducing stress concentrations in the rotor laminations. Individual laminations 29 are preferably electrically insulated from one another to reduce eddy currents that otherwise may substantially reduce performance and efficiency of electric machine 1.

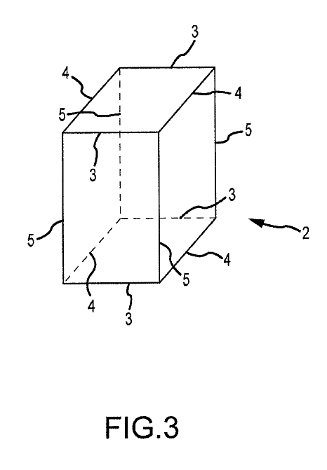

FIG. 3 shows an exemplary permanent magnet 2 formed as a rectangular column with a width defined as the linear dimension of any edge 3, a length defined as the linear dimension of any edge 4, and a height defined as a linear dimension of any edge 5. While a regular rectangular solid is described for ease of discussion, a permanent magnet of the various embodiments may have any appropriate shape. For example, magnets 2 may have rounded ends, sides, and/or corners. Respective areas bounded by edges 3, 4 may herein be referred to as magnet top and bottom. Respective areas bounded by edges 3, 5 may herein be referred to as magnet ends. Respective areas bounded by edges 4, 5 may herein be referred to as magnet lateral sides. Magnets 2 may have any appropriate size for being installed into the various magnet slots 17, 19, 21, 23. Magnets 2 are typically formed of rare-earth materials such as Nd (neodymium) that have a high magnetic flux density. Nd magnets may deteriorate and become demagnetized in the event that operating temperature is too high. When an electric machine is operating under a high temperature condition, the permanent magnets become overheated. For example, when a Nd magnet reaches approximately 320 degrees Celsius, it becomes demagnetized standing alone. When a combination of the temperature and the electric current of the machine become large, then demagnetization may also occur. For example, demagnetization can occur at a temperature of one hundred degrees C. and a current of two thousand amperes, or at a temperature of two hundred degrees C. and a current of two hundred amperes. As an electric machine is pushed to achieve greater performance, the increase in machine power consumption and associated power losses in the form of heat tests the stability of the magnets themselves. Therefore, it may be necessary to add Dy (dysprosium) to the magnet compound to increase the magnets' resistance to demagnetization. For example, a neodymium-iron-boron magnet may have up to six percent of the Nd replaced by Dy, thereby increasing coercivity and resilience of magnets 2. Although dysprosium may be utilized for preventing demagnetization of magnets 2, it is expensive, and the substitution of any filler for Nd reduces the nominal magnetic field strength. The Dy substitution may allow an electric machine to run hotter but with less relative magnetic field strength.

There is generally a maximum power output that is related to the electromagnetic limit of an electric machine, where this ideal maximum power theoretically exists in a hypothetical case where the electric machine experiences no losses. Such ideal power can be expressed as a maximum power for a short duration of time. In an actual electric machine operating in the real world, there are losses due to heat, friction, decoupling, electrical resistance, and others. A maximum continuous power that is produced when the electric machine operates continuously may be increased by removing heat from the electric machine. A buildup of heat limits the ability of the machine to run continuously. By removal of heat from the rotor, the continuous power capacity of the electric machine is increased. Cooling of electric machines, for example, has conventionally included the use of cooling jackets around a stator and nozzles for spraying a coolant on end turns of stator coils. Conventional cooling of rotors has included forming coolant channels in the rotor.

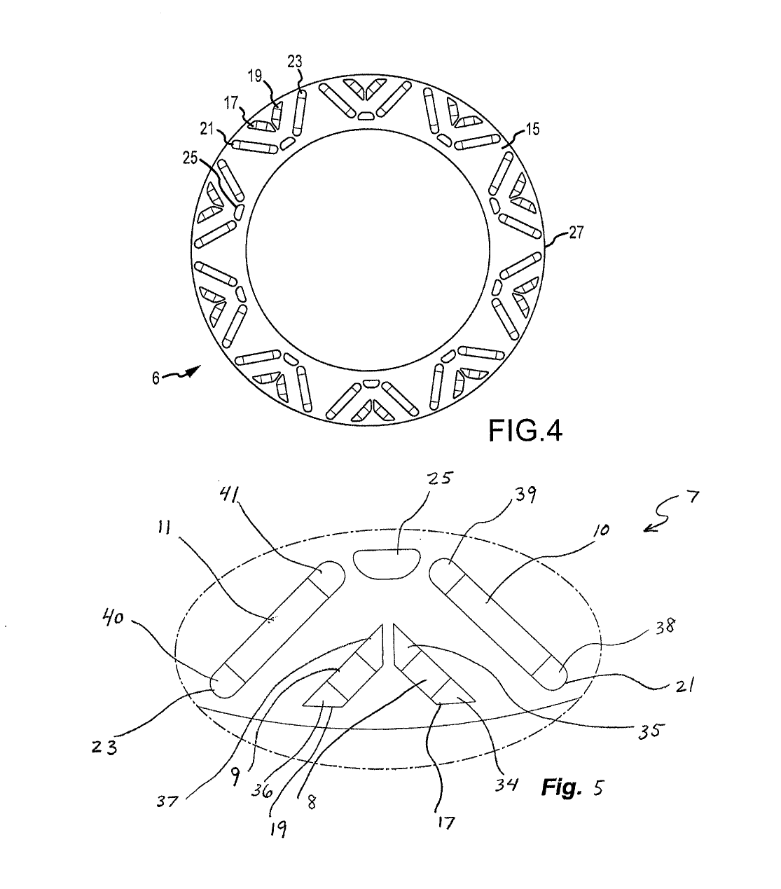

The example of FIG. 2 has ten sets of magnet slots, where each set includes magnet slots 17, 19, 21, 23, and where the sets define alternating poles (e.g., N-S-N-S, etc.) in a circumferential direction. Any appropriate number of magnet sets may be used for a given application. Magnet slots 17, 19, 21, 23 and corresponding magnets 2 may extend substantially the entire axial length of rotor core 15. FIG. 4 is a top plan view of a rotor assembly 6 having ten sets of magnet slots 17, 19, 21, 23, and FIG. 5 is an enlarged top view of one magnet set 7 thereof. Although various ones of magnet slots 17, 19, 21, 23 are shown with sharp edges, such edges may be rounded. After a permanent magnet 8 has been placed into magnet slot 17, there are gaps 34, 35 between the magnet 8 ends and the interior wall of slot 17. Similarly, after a permanent magnet 9 has been placed into magnet slot 19, there are gaps 36, 37 between the magnet 9 ends and the interior wall of slot 19. After a permanent magnet 10 has been placed into magnet slot 21, there are gaps 38, 39 between the magnet 10 ends and the interior wall of slot 21. After a permanent magnet 11 has been placed into magnet slot 23, there are gaps 40, 41 between the magnet ends and the interior wall of slot 23. Gaps 34-41 prevent a short-circuiting of magnetic flux when the direction of magnetization of respective ones of magnets is orthogonal to the magnet ends. When the magnet slots are located very close to the rotor exterior to maximize motor efficiency, only a thin bridge of rotor core material formed by the stacked laminations of the rotor separates magnet slots 17, 19, 21, 23 from the exterior surface 27 of the rotor.

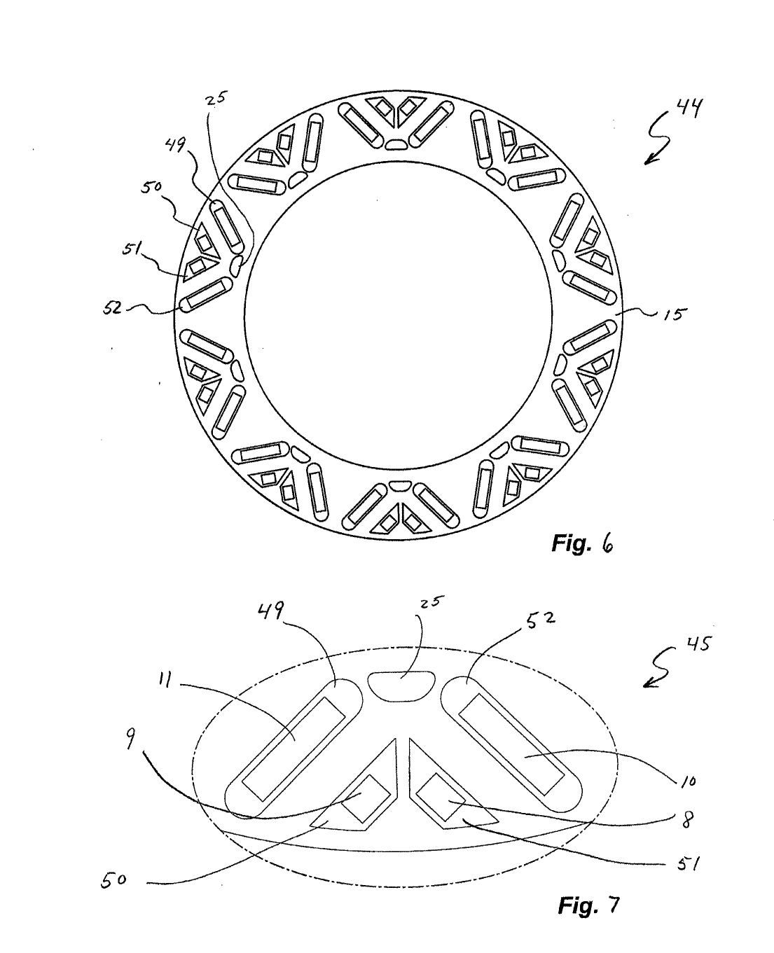

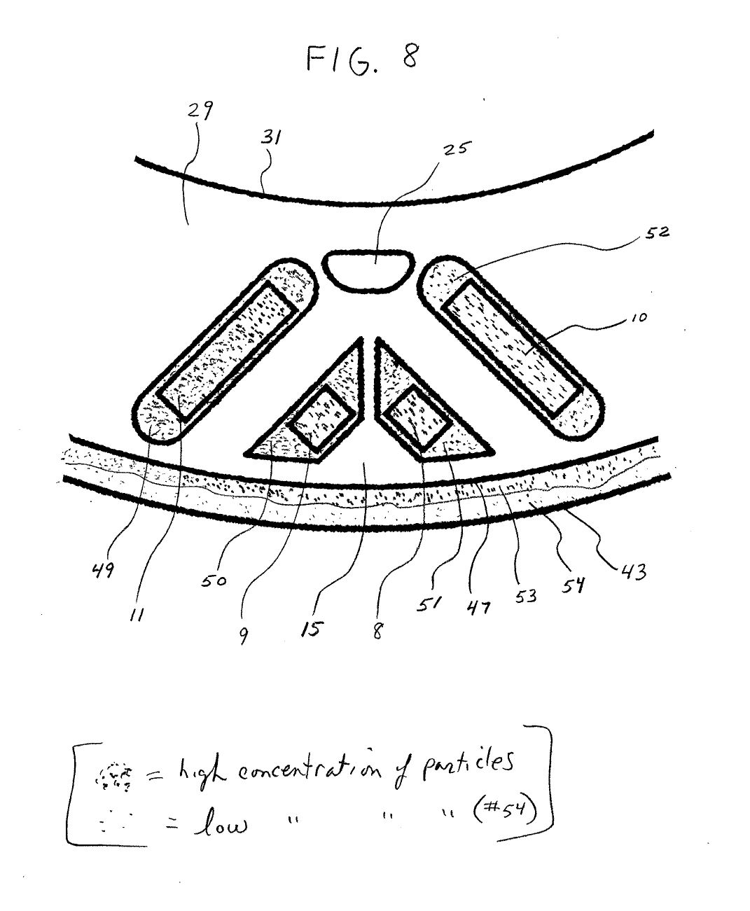

FIG. 6 is a top plan view of a rotor assembly 44 having ten sets of magnet slots 49-52, and FIG. 7 is an enlarged top view of one magnet set 45 thereof. Although various ones of magnet slots 49-52 are shown with sharp edges, such edges may be rounded. After a permanent magnet 8 has been placed into magnet slot 51, there are is a gap between magnet 8 and the interior wall of slot 51. Similarly, magnet slot 50 defines a gap around permanent magnet 9, magnet slot 52 defines a gap around permanent magnet 10, and magnet slot 49 defines a gap around permanent magnet 11.

Manufacturing of individual laminations 29 typically may include rolling of steel into sheet material, coating the sheet material with a thin layer of electrical insulation, blanking/punching the sheet to form individual laminations 29 and, if appropriate, annealing. Such coating may be performed before, during, or after a blanking/stamping process or an annealing process. Typically, fully processed silicon steel sheeting is annealed and coated at the steel mill. The subsequent metalworking processes that include stamping cause the magnetic properties of laminations to worsen because the material becomes stressed. In particular, stresses caused by punching degrade the grain structure in the edge portions of laminations 29, which reduces performance. Further annealing relieves residual stress induced by such shaping processes. Such post-stamping annealing removes the effects of strain hardening and laminations 29 regain the original grain structure. The insulative coating must be able to withstand annealing temperatures of approximately 700 degrees Celsius. Annealing may be absolutely required in some applications having high flux density and/or tight rotor core geometries. The least expensive insulative coating is known as C-0, which is a thin, low resistance, tightly adherent oxide coating that is applied at the steel mill or during the annealing process after stamping. A C-3 coating is an enamel or varnish that provides excellent insulation but does not withstand annealing temperatures. A C-4 coating has a higher resistance than a type C-0 and will withstand annealing temperatures. A C-5 coating has a still higher resistance and may be adapted to withstand annealing. Some coating types may optionally be applied during or after annealing. Annealing may also be performed when laminations 29 are uncoated. When annealing is not performed, a higher grade steel material may be required in order to obtain laminations 29 having acceptable magnetic properties.

It is difficult to efficiently manufacture a large number of laminations 29 while maintaining tight dimensional tolerancing. Individual laminations 29 are not perfectly flat, and air spaces are formed between laminations 29 in a stack. In particular, when laminations 29 are stacked, the average axial spacing between adjacent laminations is two to three microns (micro-meter) due to surface irregularities, slight warping, handling, and other causes. It is also common for the thin (e.g., 6-8 microns) coating of electrical insulation to be compromised by abrasion and chipping. Similarly, manufacturing processes and associated handling may chip and remove insulative coating, resulting in uncoated portions in laminations 29, especially at the inner and outer circumferential edges, whereby electrical shorting may occur when uncoated portions come into contact. Such shorting reduces the efficiency of electric machine 1 and creates significant additional heat in high-performance machines having high current and magnetic flux densities.

In an exemplary embodiment, a low-viscosity epoxy resin is injected into space that includes gaps 34-41 in a process that prevents air from becoming entrapped therein. For example, a heat curing, two component epoxy formulation available from Lord Corporation and having a part number EP-830 may be used. The epoxy resin is mixed/compounded with thermally conductive reinforcements that dramatically increase thermal conductivity. The thermally conductive filler materials may contain polymers, and may contain alumina, boron nitride, or other suitable thermally conductive additives. Thermally conductive polymers generally have higher flexural and tensile stiffness, and lower impact strength compared with conventional plastics, and may be electrically non-conductive. Typically, thermally conductive polymers may have thermal conductivities that range from 1 to 20 W/(m·K). In another example, a boron nitride having a high thermal conductivity may be formed in a ceramic binder, whereby a thermal conductivity of the ceramic mixture may be as high as one hundred twenty-five W/(m·K) or more. In an exemplary embodiment, the thermally conductive additives may be particles each having a size greater than 5-6 microns. In an exemplary process, sheet silicon steel having a C-4 coating is stamped into individual laminations 29 and then annealed. Laminations 29 are then placed into a mold or similar fixture having a center core and a structure for aligning laminations 29 being placed on top of one another. For example, hub 33 may include one or more radially protruding keys (not shown), and laminations 29 may each have corresponding notch(es) that mate with such keys for effecting the alignment. The assembled laminations 29 are then pressed together within the mold and secured in place so that the height of the assembled stack is fixed at the nominal value. The EP-830 epoxy resin mixed with additives may be pressure/vacuum injected into the mold to remove air bubbles, and/or the mold may be placed onto a vibration table and vibrated during injection. When the mold is filled from the bottom, pressure/vacuum may not be required when air bubbles are adequately displaced. The epoxy resin has a low viscosity that allows it to completely fill all magnet slots 17, 19, 21, 23 and to permeate the spaces between adjacent laminations 29. When filling the mold without pressure/vacuum, the rate of injection should be optimized so that air bubbles are freely exhausted.

FIG. 8 is a partial top plan view of an assembled rotor core 15 after injection of epoxy resin. The assembly process includes stacking laminations 29 atop one another in a mold 43 and placing magnets 8-11 into ones of magnet slots 49-52. The epoxy resin injection process includes masking off the circumferential inside wall 31 of rotor core 15 and axial slot 25, and then injecting the epoxy resin so that all exposed spaces become filled. In addition, a portion of the low viscosity epoxy resin fills top and bottom spaces between axially adjacent ones of the stacked laminations 29 by capillary action. In particular, the average axial dimension of gaps between laminations 29 is approximately two to three microns, whereas the size of highly thermally conductive additives in the resin epoxy is typically greater than about six or seven microns. The axially adjacent lamination edges 47 therefore act as ersatz 2-3 micron filters that prevent substantially all such thermally conductive additives from entering the axial spaces between laminations 29. Instead, the thermally conductive additives become concentrated in volumes around permanent magnets 8-11 and in a high filler concentration volume 53 extending circumferentially around the outer cylindrical surface of rotor core 15. A volume 54 of normal filler concentration is formed between high filler concentration volume 53 and mold 43. As a result, the volumes that require the most heat transfer, namely magnet slots 49-52 and the space adjoining the circumferential outer edge 47 of rotor core 15, have the highest thermal conductivity. The base material of the resin epoxy has a low viscosity that allows it to thoroughly penetrate rotor body 15 and completely fill the axial spaces between laminations 29. The absence of thermally conductive additives in such spaces between laminations 29 allows the additives to be concentrated where they are most needed. The top and bottom spaces adjacent the respective axial ends of magnets 8-11 are also filled with the portion of the epoxy resin having the high concentration of thermally conductive additives, whereby magnets 8-11 are substantially completely encapsulated.

The space 25 (e.g., FIGS. 4-5) may optionally be utilized for providing a coolant channel or for guiding the flux about permanent magnets 8-11 within a magnet set 7. For example, steel and/or resin may be selectively placed into or floated within space 25, or space 25 may be masked off during injection of the epoxy resin. In various embodiments, injection of epoxy resin having a thermal conductivity of greater than 0.3 W/(m·K) was found to significantly increase output power. In other embodiments, an epoxy resin having thermal conductivity of greater than approximately 0.5 to 0.6 W/(m·K) was found to further increase output power while still providing acceptable structural performance. Other embodiments may have an epoxy resin with thermal conductivity of 1.4 W/(m·K), and a resin for some applications may be formed with thermal conductivity of 3.0 to 4.0 W/(m·K) or greater, depending on the machine operating conditions related to temperature and current. For example, epoxy resin material may be created to have a desirable thermal conductivity but such may not be suitable for durability, electrical properties, structural integrity, high temperature stability, thermal expansion properties over a wide temperature range, cost, and other reasons. In particular, the coefficient of thermal expansion (CTE) of the epoxy resin is substantially higher than that of steel laminations 29 and permanent magnets 8-11. As a result, any long column of epoxy resin in an unbroken state may cause unwanted expansion of such column at high operating temperatures. In such a case, one or more fibrous materials may be placed to interrupt/break a length of epoxy resin. For example, epoxy resin along lengthwise sides of magnets 8-11 may extend 115 mm or more in a generally axial direction, and epoxy resin columns having such length may be affected by thermal expansion. In order to greatly reduce the effects of thermal expansion in these spaces, fibers such as carbon fiber, aramid fiber, fiberglass, metal fiber, or other fibrous material that does not interfere with the electromagnetic function of the rotor, may be placed alongside lengthwise sides of magnets 8-11, thereby interrupting relatively long columns of epoxy resin. Such fibers may be impregnated with a material that also serves as a thermal conductor. For example, fibers may be impregnated with a thermoplastic material such as polyetheretherketone (PEEK), which act to mechanically isolate the interrupted sections of a long epoxy resin column while still maintaining thermal conductivity. Fiber material may optionally include material such as nylon resins designed for toughness, structural integrity in high temperature, coefficient of linear thermal expansion, dielectric constant, chemical resistance, etc.

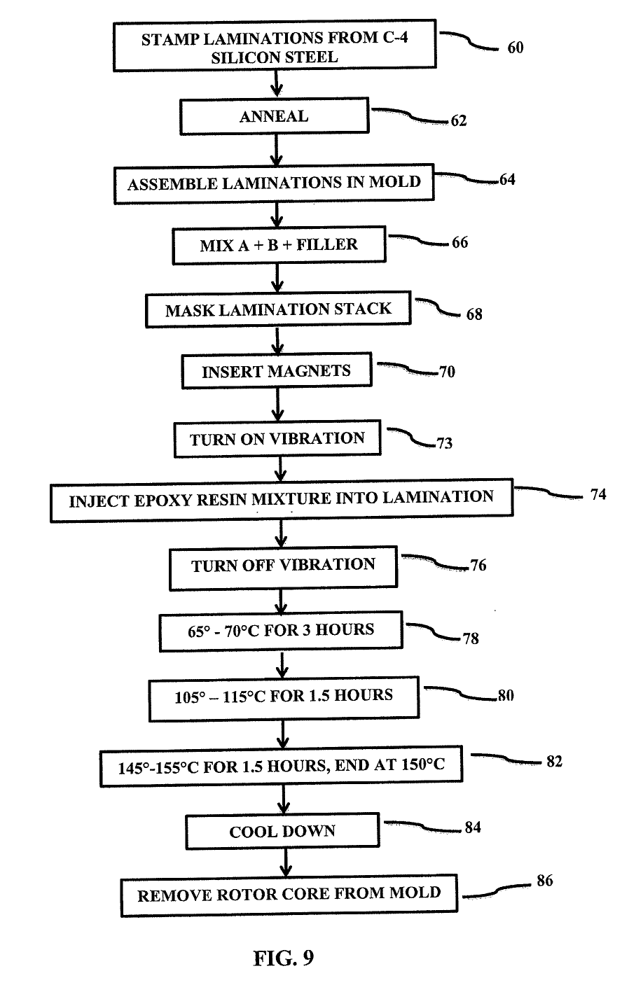

FIG. 9 is a flowchart illustrating an exemplary rotor manufacturing method. At step 60, laminations 29 are blanked/stamped from sheet silicon steel that has been received from a steel mill already annealed and coated with a C-4 type electrical insulation having a coating thickness of approximately 6-7 microns. At step 62, the laminations 29 are further annealed to relieve material stress imposed by the stamping, to recover grain structure, and to remove any excess carbon dust or other unwanted debris. The axial height of lamination 29 may be reduced by the annealing because of improved flatness. At step 64, a number of laminations 29 are stacked and aligned in a mold having a substantially cylindrical interior with a diameter slightly larger than that of laminations 29. The lamination stack is then pressed axially together until the stack height has the desired nominal value, and the pressing apparatus (not shown) is locked in place. The mold may be a pressure chamber suitable for applying pressure/vacuum to an interior thereof. At step 66, the two-part epoxy resin (resin A and hardener B) is mixed together with a thermally conductive additive having particles such as alumina of approximately 6-7 microns in diameter. At step 68, the inner circumferential surface (ID) of the lamination stack is masked off with a thermally resistant material and/or placed into abutment with a hub or other rotor structure. Similarly, any axially oriented passages such as space 25 (e.g., FIG. 8) may be filled with a temperature resistant masking material that may be easily removed at a later stage of manufacturing. At step 70, fiber material is placed into magnet slots 49-52 (e.g., FIG. 8) or such fiber is alternatively attached to permanent magnets 8-11, and magnets 8-11 are then placed into ones of longitudinally oriented magnet slots 49-52 so that each group of magnet slots 49-52 is populated. At step 71, the mold and its contents are placed inside an oven (not shown) that has been preheated to approximately sixty degrees Celsius. Fluid connections are made between the mold and an epoxy resin supply, a pressure/vacuum source (if used), and a venting port. The mold may be placed on a vibration table (not shown) within the oven. At step 72, the mold is heated for approximately one hour at sixty degrees Celsius. At step 73, the vibration table is turned on and, at step 74, the epoxy resin mixture is injected into the mold at a port in the bottom surface thereof. The vibration magnitude and frequency are controlled, and the rate and volume of epoxy resin injection are controlled to assure that air does not become trapped within rotor core 15 (e.g., FIG. 2). When the process is optimized, air is pushed generally upward as epoxy resin fills the mold. The very low viscosity of the epoxy resin allows it to completely fill inter-lamination spaces by capillary action, and the rate of flow combined with vibration removes ancillary air bubbles that would otherwise be trapped between laminations 29. Optionally, pressure or vacuum may be applied to the interior of the mold to thoroughly remove all air from the spaces being filled with epoxy resin. After completely filling rotor core 15 with epoxy resin and removing entrapped air, the vibration table may be turned off at step 76. At step 78, the mold and rotor core are heated at 65-70° C. for three hours. The vent in the mold assures that fumes are exhausted and that heat is evenly distributed. At step 80, the mold and rotor core are heated at 105-115° C. for 1.5 hours. The increased temperature further reduces the viscosity of the epoxy resin, and the reduced viscosity allows the epoxy resin to further separate from its included thermally conductive additives which further concentrates such thermally conductive particles around magnets 8-11 and around lamination edges 47. The lowered viscosity epoxy resin may further permeate inter-lamination spaces and, therefore, the vibration table may again be turned on for a period of time to assure the complete removal of any extraneous air bubbles. At step 82, the mold and rotor core are heated at 145-155° C. for 1.5 hours. The transition to the elevated temperature includes the glass transition temperature at approximately 127° C. The epoxy resin cross-links and cures at the elevated temperature, and thereby sets as a solid. At step 84, the heat is turned off, and the mold and its contents are removed from the oven and allowed to cool. At step 86, rotor core 15 is removed from the mold.

Further processing may include turning and machining rotor core 15 to remove epoxy resin radially outward of lamination edges 47, thereby removing any longitudinally oriented unbroken lengths of epoxy resin and avoiding any operational problems of thermal expansion. The processing time for injecting and curing the epoxy resin may be substantially decreased by use of inductive heat processes. The exemplary temperatures and process times will necessarily vary depending on the particular epoxy resin and additive mixture, and its associated specifications. A high curing temperature of the mixture allows control over viscosity during processing because, generally, as temperature increases, viscosity becomes lower. By raising the temperature, viscosity is thereby reduced to a point where the epoxy resin reaches a flow temperature (e.g., 105-115 degrees C.) and capillary action occurs easily so that the epoxy resin flows readily between laminations and pushes out any remaining air. Such flow temperature will vary depending on the exact epoxy resin being used.

Permanent magnets 8-11 may be magnetized after rotor assembly 24 has been completely assembled. When a high pressure is utilized for injecting the epoxy resin, tight tolerances for molds contain the pressure and assure that thin portions of laminations 29 of rotor body 15 are not thereby deformed. Elevated pressure allows air bubbles and other voids to be easily removed, whereby thermal conductivity is not compromised. Optionally, the mold may include permanent magnets (not shown) arranged to precisely face the rotor pole locations. Corresponding permanent magnets 8-11 may be placed into magnet slots 49-52 so that they are floating during the injection of epoxy resin. Magnets 8-11 become precisely aligned in their correct position by being magnetically attracted to the fixed mold magnets. By floating permanent magnets 8-11 prior to completing the encapsulating, permanent magnets 8-11 become finally bonded into a static position based on magnetic alignment. In another exemplary option, laminations 29 may have protrusions along upper or lower surfaces to define consistent axially oriented spaces between adjacent laminations. For example, a lamination may have precisely toleranced waves or bumps so that stacked laminations consistently have a precise axial gap therebetween.

In operation, heat of permanent magnets 8-11 is transferred by the thermally conductive epoxy resin into the lamination stack of rotor body 15. Permanent magnets 8-11 and the lamination stack of rotor body 15 both act as thermal conductors. When a hub 33 is part of rotor assembly 24, such hub 33 conducts the heat of the lamination stack. Oil or other coolant may be in fluid communication with hub 33, and a heat exchanger (not shown) such as an external oil cooler, or hub 33 may be in fluid communication with coolant of cooling jacket 42 (e.g., FIG. 1) for removing heat from the oil. As a result, the conventional problem of having permanent magnets as “hot spots” within a rotor is reduced by encapsulating permanent magnets 8-11 with compound having thermal conductivity of greater than 0.3 W/(m·K), and preferably at least 0.55 to 0.6 W/(m·K). The reduced effects of high temperature on a rotor provide substantial improvements in thermal control for electric machines having a high operating speed and a densely packed design. For example, machines may operate at a continuous speed over 10,000 rpm and have a power output of three hundred kilowatts. The associated high current (specifically, amp-turns) acts together with the temperature of the electric machine to produce conditions where permanent magnets demagnetize. For example, in a conventional machine, permanent magnets may be damaged under a no-load condition at approximately 320 degrees Celsius, or with a 600 Amp current at 200 degrees C. By use of the various embodiments that improve heat transfer out of a rotor, such damage is avoided.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A rotor, comprising:
a plurality of laminations arranged in a stack having a plurality of longitudinally extending magnet slots;
a plurality of permanent magnets in respective ones of the magnet slots; and
a low-viscosity epoxy resin encapsulating the permanent magnets and substantially covering each of the laminations in the stack, the epoxy resin having thermal conductivity greater than 0.3 watts/(meter*degree Kelvin).

2. The rotor of claim 1, wherein the epoxy resin has thermal conductivity greater than 0.5 watts/(meter*degree Kelvin).

3. The rotor of claim 1, wherein the epoxy resin has thermal conductivity greater than 1.2 watts/(meter*degree Kelvin).

4. The rotor of claim 1, wherein the epoxy resin has thermal conductivity of greater than 3.0 watts per (meter*Kelvin).

5. The rotor of claim 1, wherein the epoxy resin is partitioned so that the magnet slots are filled with a first portion and axial spaces between the laminations are filled with a second portion of the epoxy resin, and wherein the first portion has thermal conductivity greater than that of the second portion.

6. The rotor of claim 1, wherein the epoxy resin includes thermally conductive polymers.

7. The rotor of claim 6, wherein the polymers comprise alumina.

8. The rotor of claim 6, wherein the polymers comprise boron nitride.

9. A method of forming a rotor, comprising:
placing a plurality of laminations into a stack having a plurality of longitudinally extending magnet slots;
placing a plurality of permanent magnets into ones of the magnet slots; and
injecting a low viscosity epoxy resin into the lamination stack, thereby substantially filling the magnet slots with a portion of the epoxy resin having a thermal conductivity greater than 0.3 Watts/(meter*degree Kelvin) and substantially filling axial spaces between adjacent ones of the laminations with a portion of the epoxy resin having a thermal conductivity less than that of the epoxy resin in the magnet spaces.

10. The method of claim 9, further comprising placing fiber into the magnet slots.

11. The method of claim 9, further comprising placing fiber about respective longitudinal sides of ones of the permanent magnets and including such fiber when placing the permanent magnets into the magnet slots.

12. The method of claim 9, further comprising heating the lamination stack to a first temperature for lowering viscosity of the epoxy resin and facilitating separation of the epoxy resin into the two portions and then raising the heat to a second temperature for solidifying the epoxy resin.

13. The method of claim 9, further comprising floating the permanent magnets, whereby such permanent magnets are finally bonded into a static position based on magnetic alignment.

14. A method of forming a rotor, comprising:
arranging a plurality of laminations as a stack having a plurality of longitudinally extending magnet slots;
placing a plurality of permanent magnets into respective ones of the magnet slots; and
substantially encapsulating the permanent magnets and each of the laminations with a low-viscosity epoxy resin having thermal conductivity greater than 0.3 watts/(meter*degree Kelvin).

15. The method of claim 14, further comprising vibrating the lamination stack while performing the encapsulating.

16. The method of claim 14, wherein the encapsulating includes applying a pressure/vacuum for forcing air out of the lamination stack.

17. The method of claim 14, wherein the encapsulating includes substantially filling the magnet slots with a first portion of the epoxy resin and substantially filling axial spaces between adjacent ones of the laminations with a second portion of the epoxy resin, and wherein the first portion has thermal conductivity greater than that of the second portion.

18. The method of claim 17, wherein the first portion of the epoxy resin includes alumina.

19. The method of claim 17, wherein the first portion of the epoxy resin includes boron nitride.

20. The method of claim 14, further comprising floating the permanent magnets, whereby such permanent magnets are finally bonded into a static position based on magnetic alignment.
